(19) United States
(12) Patent Application Publication
(10) Pub. No.: US 2021/0283575 A1
(43) Pub. Date: Sep. 16, 2021

(54) SYSTEMS AND METHODS FOR MANUFACTURING GRANULES

(71) Applicant: BENEFICIATE: NORTH AMERICA, LLC, Greene, NY (US)

(72) Inventors: Keith C. Day, Greene, NY (US); John Lewis, Greene, NY (US); Ethan G. Day, Greene, NY (US)

(21) Appl. No.: 16/620,056

(22) PCT Filed: Jun. 6, 2018
(86) PCT No.: PCT/US2018/036222

§ 371 Date: Dec. 6, 2019

Related U.S. Application Data
(60) Provisional application No. 62/515,632, filed on Jun. 6, 2017.
(60) Provisional application No. 62/536,791, filed on Jul. 25, 2017.

(51) Int. Cl. B01J 20/24; B01J 20/04; B01J 20/10; B01J 20/28; B01J 20/30; B01J 20/16; B01J 2/00; A01K 1/015

(52) U.S. Cl. CPC B01J 20/24; B01J 20/045; B01J 20/103; B01J 20/2803; B01J 20/3042; A01K 1/0155; B01J 20/3021; B01J 20/16; B01J 20/28004; B01J 2/00; B01J 20/3028

(57) ABSTRACT

Disclosed herein are novel compositions for the production of granule products, and uses of the same. Said granule products may comprise one or more of an input material, fibers, a binder, moisture, and an additive. Also disclosed are processes and systems for making the same and methods of using the same. A process for manufacturing granules may include mixing and granulating input material, fibers, a binder, and water using a mixer to produce wet granules, drying and cooling the wet granules, and separating at least one of dry overs and dry fines from the dried, cooled granules using a classifier.

### RELATED APPLICATIONS

This application claims the benefit of priority of U.S. provisional application No. 062/515,632, filed Jun. 6, 2017, and U.S. provisional application No. 62/536,791, filed Jul. 25, 2017, each of which is incorporated herein by reference in its entirety.

### TECHNICAL FIELD

This present disclosure relates generally to systems and methods for manufacturing granule products. More particularly, the present disclosure relates to system and methods for manufacturing granule products that include an input material (e.g., synthetic gypsum), fibers, a binder, and moisture.

### BACKGROUND

Systems and methods for manufacturing pellets or granules can employ a variety of techniques and machinery. For instance, U.S. Patent Application Publication No. 2016/0159691 A1 (the '691 publication) discloses a method of manufacturing pellets or granules. The disclosure of the '691 publication is incorporated herein by reference. Although the '691 publication provides a method, it may be less than optimal. For example, the system and method of the '691 publication may not maximize efficiency in recycling input materials, may require excess process steps, and/or may lack the ability to control the method based on the variable properties of the input material. Furthermore, the '691 publication does not disclose method of manufacturing the products of the present disclosure.

The systems and methods of the present disclosure are directed to overcoming one or more of the shortcomings and problems set forth above and/or other problems with existing technologies.

### SUMMARY

The disclosed systems and methods can process materials, such as wet synthetic gypsum (e.g., calcium sulfate dihydrate, CaSO₄.2H₂O) and cellulose material, such as milled construction paper cuttings, paper mill sludge, or diaper fluff, into a product, e.g., granules. The resulting product can be lightweight and/or sorbent, e.g., absorbent and/or adsorbent. In some embodiments, the systems and methods can incorporate oversized granules and undersized granules into the final product using a system of classifiers, mills, conveyors, and weigh bins to minimize creation of byproducts (e.g., the disclosed methods may produce substantially zero byproducts). A granulation system, e.g., a high-intensity mixer or paddle agitator mixer with chopper, can be used to mix and granulate ingredients. In some embodiments, substantially all of the granules can be produced with similar relative roundness or jaggedness.

While the disclosed systems and methods can be used with materials such as synthetic gypsum and cellulose material to produce sorbents, these systems and methods are not limited to such ingredients or products. For example, the method described here could be used to beneficiate gypsum and cellulose for a number of uses, or to beneficiate materials other than gypsum. For example, the disclosed systems and methods can be used to produce oil absorbents, soil amendments, erosion control materials, and fertilizers. As would be recognized by one of skill in the art, the ingredients, mix times, tooling speeds, drying temperatures, drying times, and settings of the classifiers can depend on the target end-product. Similarly, the materials used in the disclosed systems and methods can be recycled materials or other manufactured materials.

It is to be understood that both the foregoing general description and the following detailed description are exemplary and explanatory only and are not restrictive of the disclosed embodiments, as claimed.

### BRIEF DESCRIPTION OF THE DRAWINGS

The drawings are not necessarily to scale or exhaustive. Instead, emphasis is generally placed upon illustrating the principles of the inventions described herein. The accompanying drawings, which are incorporated in and constitute a part of this specification, illustrate several embodiments consistent with the disclosure and together with the description, serve to explain the principles of the disclosure. In the drawings:

FIG. 1 depicts a front view of an exemplary system for manufacturing granules comprising a blending station and a processing station, consistent with disclosed embodiments.

FIG. 2 depicts a side view of the exemplary processing station of FIG. 1, consistent with disclosed embodiments.

FIG. 3 depicts a top view of the processing system of FIGS. 1 and 2, consistent with disclosed embodiments.

FIG. 4 depicts a top view at an elevation of a fluidized bed dryer portion of the processing system of FIGS. 1-3, consistent with disclosed embodiments.

FIG. 5 depicts an exemplary flowchart of a process for making sorbent granules, consistent with disclosed embodiments.

FIG. 6 depicts another exemplary flowchart of a process for making sorbent granules, consistent with disclosed embodiments.

FIG. 7 depicts another exemplary system for manufacturing granules comprising a blending station and a processing station, consistent with disclosed embodiments

FIG. 8 depicts another exemplary flowchart of a process for making sorbent granules, consistent with disclosed embodiments.

### DETAILED DESCRIPTION

The disclosed subject matter concerns systems and methods for mixing and granulating ingredients using a high-shear mixer. The production process can incorporate byproducts in a manner enabling subsequent separation and reuse of such byproducts leading to a no-, or nearly no-waste process. For example, granules failing to meet specifications may be reintroduced into the high-shear mixer. These granules may be reintroduced in a specific way that enables the output of the high-shear mixer to be separated into granules meeting specification and granules failing to meet specification. The granules failing to meet specification can then be re-introduced, increasing efficiency and reducing waste.

In some embodiments, the disclosed systems and methods can use gypsum, such as synthetic gypsum (e.g., flue gas desulfurization or “FGD” gypsum, a byproduct of coal-fired power plants). In some embodiments, the disclosed systems and methods can use artificial pozzolans, such as metakaolin, fly ash, silica fume, or burned organic matter (e.g., rice husk ash) and/or natural pozzolans such as volcanic ashes, pumices, volcanic glass, zeolites, or diatomaceous earth.

The disclosed systems and methods can use materials, such as the exemplary starting materials listed above, to produce a lightweight sorbent material. In some embodiments, the material may be odorless. In some embodiments, the material may have an odor. In some embodiments, the odor may be caused by introduction of an additive, e.g., a fragrance agent. For example, according to disclosed embodiments, synthetic gypsum can be combined with a given ratio of reclaimed cellulose fibers. In some embodiments, the synthetic gypsum can be in a wet form (e.g., 8-20% moisture) or powdered form. In some embodiments, the cellulose fibers can be derived from milled construction paper cuttings, paper mill sludge, diaper fluff, or similar material. In some embodiments, the cellulose fibers can be received in a compacted bail form or bulk bag. In some embodiments, the cellulose fibers can have less than about 10% moisture content, less than about 5% moisture content, or, in some embodiments, preferably less than about 1% moisture content. In some embodiments, when paper mill sludge is the source of cellulose fibers, the fibers may have up to about 75% moisture content, or, in some embodiments, preferably 50% or less moisture content.

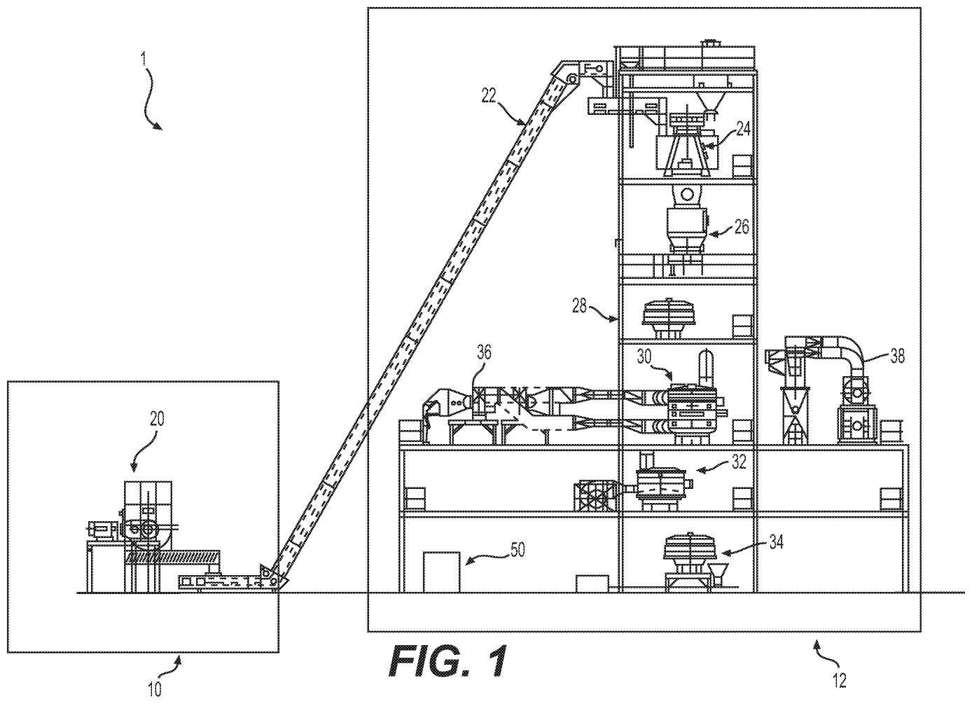

As shown in FIG. 1, a processing system 1 may comprise blending and processing steps that may be performed at a manufacturing blending station 10 and a processing station 12, consistent with disclosed embodiments. The ratios of ingredients and processing times in each of the processing and blending steps may be coordinated by a control system 50 that accounts for input variability. As would be appreciated by one of skill in the art, such input variability can arise from the use of recycled or “byproduct” materials. Such materials may exhibit a far greater range of characteristics than materials intended for use as inputs, which are typically manufactured to satisfy a specification. For example, moisture content in byproducts like synthetic gypsum can vary greatly. Control system 50 may be configured to monitor the characteristics of input ingredients using sensors such as scales and meters and to automatically account for this variability at least by (i) varying the ratios of ingredients (including water) added to continuous paddle mixer and high-shear mixer described in detail below, and (ii) adjusting the cycle times and ingredient addition timings for these mixers. Control system 50 may be implemented using a programmable logic controller (PLC).

Blending station 10 may be configured to perform at least chunking of cellulose fibers and mixing of cellulose fibers with gypsum. According to an exemplary process, bales of dry cellulose fiber may be placed on an infeed trough idler cam-belt conveyor. The bales may then be transferred to a cellulose lumpbreaker/shredder (not shown). The lumpbreaker/shredder can be configured to chunk the material. For example, the lumpbreaker/shredder can be configured to reduce the amount of “fluffed” cellulose (e.g., the amount of disaggregated cellulose fibers). The chunked cellulose fiber may then be weighed by one or more AIS electronic load cells on the cellulose shredder discharge hopper. The cellulose chunks may be metered and fed into the continuous mixer at a ratio determined by control system 50.

According to another exemplary process, an input material, such as gypsum, may be received and emptied into an at-grade screen (e.g., a grizzly screen or similar screen), passing into a live surge hopper. The gypsum can be synthetic gypsum produced, for example, produced as a waste by-product at a power plant. The gypsum may be delivered, for example, in dump trailers. Once delivered, a live bottom screw feeder may then move the gypsum from the surge hopper into the heavy-duty weigh belt feeder. The gypsum may then be weighed to ±1% accuracy. The weigh belt feeder discharge surge hopper may transfer the gypsum to a take-away through idler cam-belt conveyor which can deposit the synthetic gypsum into a continuous paddle mixer 20 with choppers.

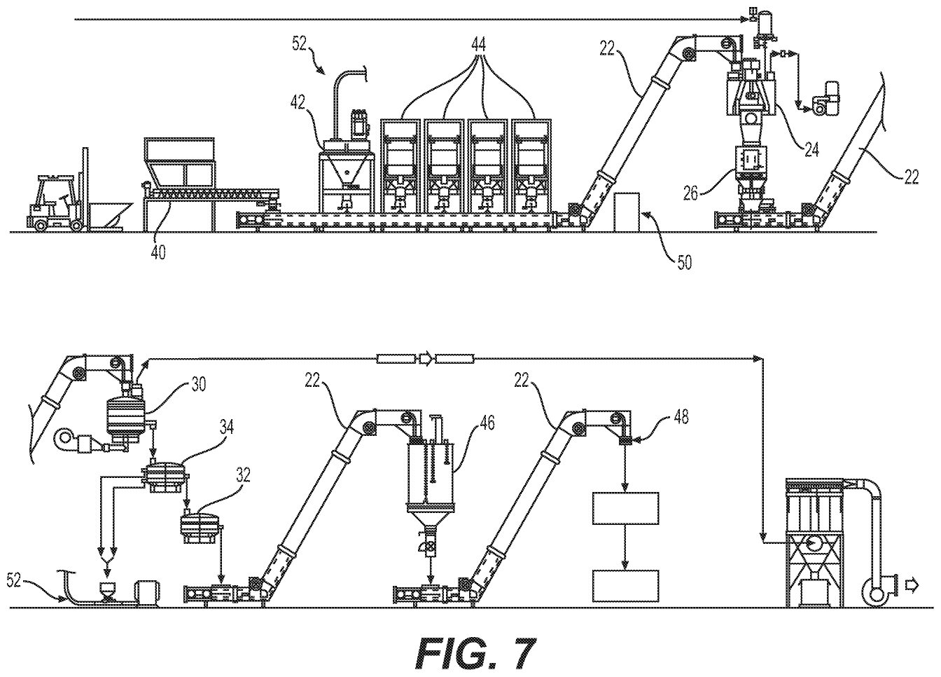

Paddle mixer 20 can be configured for a range of working volumes and fill levels, e.g., about 1,200,000 pounds per day per eight-hour shift or 125,000 pounds per hour with a 50% turn-down ratio, which may depend on the material infeed density. As a non-limiting example, paddle mixer 20 may be configured for a 530 cubic feet working volume at 50% fill level or 265 cubic feet based on a material infeed density of 44.7 pounds per cubic foot. Paddle mixer 20 may be configured with choppers that will chop the cellulose chunks into a uniform gypsum-cellulose mix to form the base feed material (“BFM”). For example, paddle mixer 20 may be configured with 216 choppers. The BFM may be discharged from the continuous mixer into a transfer hopper feeding a take-away idler cam-belt stockout conveyor 22. In some embodiments, blending station 10 can be designed to stockpile the BFM. For example, blending station 10 may be designed to stockpile 9,000 tons of BFM. In some embodiments, the fiber may be received in smaller quantities, e.g., 40 lb. bails, which are manually weighed and placed directly into the mixer, as shown in FIG. 7.

As shown in FIG. 1, exemplary processing station 12 may comprise a high-shear mixer 24, a table feeder 26, a primary classifier 28, a fluidized bed dryer 30, a fluidized bed cooler 32, and a secondary classifier 34, which may work cooperatively to produce a product in accordance with the disclosed embodiments. These machines may be configured to perform high-shear mixing, table feeding, primary classification, and fluidized bed drying and cooling. In some embodiments, these machines may be configured to also perform secondary classification processes and other processes which one of ordinary skill in the art may appreciate. In various embodiments, at least some of the processing steps may be performed as part of blending process performed by the blending station 10. These components may be controlled using a process control system 50.

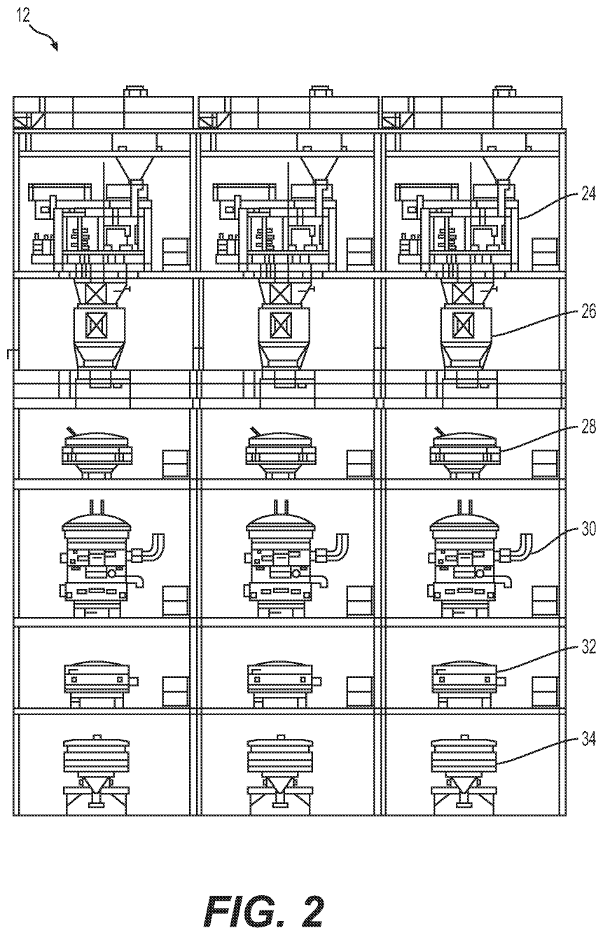

FIG. 2 is a side view of the exemplary processing station of FIG. 1. As shown in FIG. 2, exemplary processing station 12 may include multiple parallel processing lines, which may increase manufacturing versatility. Although the illustrated embodiments show three processing lines, in other embodiments processing station 12 may include less than three (e.g., two or one) or more than three (e.g., four, five, etc.) processing lines. The increased manufacturing versatility may enable one or two processing lines to be running while the third line is being cleaned or in standby. Alternatively, the number of lines running may be selectable based on production demand. For example, when maximize production is desired then all three processing lines may be operating while when lower production is desired one or two processing lines may be operating.

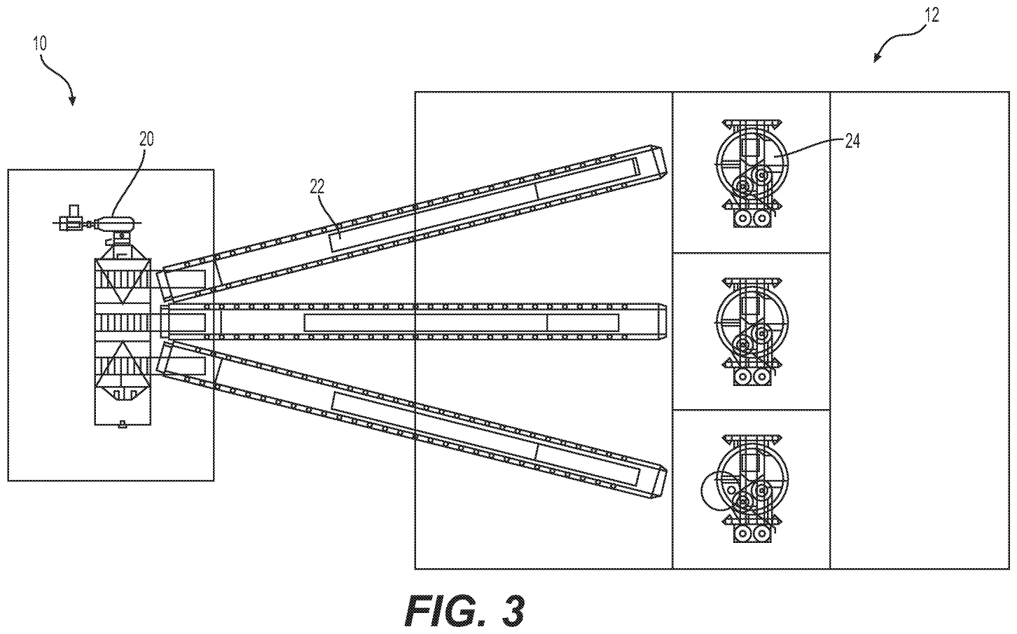

FIG. 3 is a top view of processing system 1 of FIGS. 1 and 2. As shown in FIG. 3, processing station 12 may be configured such that high-shear mixers 24 are charged with the BFM from blending station 10 via conveyors 22, and additional ingredients. In some embodiments, the BFM can be retrieved from a stockpile, e.g., with a front-end loader and deposited into an incoming agitated surge hopper (not shown). The bottom of the surge hopper may be configured with dual screw conveyors that discharge the BFM from the surge hopper onto, e.g., inclined belt conveyors 22. For example, the dual screw conveyors may discharge the BFM onto inclined belt conveyors 22. Such conveyors may transfer the BFM from blending station 10 to processing station 12. For example, the BFM may be transferred to the top of processing station 12. Conveyors 22 may also transfer the BFM to weigh belt units which weigh the BFM and meter it for granulation, e.g., by depositing BFM into corresponding high-shear mixers 24 (e.g., one or more Lancaster Products K-Series High Shear Mixers, Eirich Intensive Mixers, or similar mixers) according to a ratio calculated by control system 50. In some embodiments, granulation of materials may be achieved by using an alternative means, e.g., a paddle agitator mixer with chopper. For example, where a denser granule is desired a high shear mixer may be utilized, while a paddle agitator mixer with chopper may be utilized when a less dense granule is desired. Control system 50 may determine the appropriate ratio based on characteristics of the BFM, such as, e.g., the moisture content of the BFM.

In some embodiments, each high-shear mixer 24 can be charged with additional ingredients according to ratios calculated by control system 50. For example, high-shear mixer 24 may be charged with fines generated and collected during manufacturing of previous batches of the end-product. These fines may be used as “seed” particles to assist granulation of the BFM. Additionally or alternatively, such fines may be used to dry the incoming BFM. In various embodiments, each high-shear mixer 24 may be charged with a binder, for example starch, (e.g., recycled, off-specification corn starch powder or nonrecycled corn starch powder (e.g., ChemStar StarTak 100)), a cellulose ether (e.g., high purity sodium carboxymethylcellulose (e.g., Aquasorb™ A500)), a lime-based ash byproduct, and/or silicon dioxide, which may be chemically prepared in solid powder form (e.g., SIPERNAT® 50 S). In some embodiments, the binder, such as silicon dioxide, may be used to increase the rate of liquid absorption. In some embodiments, a binder may prevent premature absorption (e.g., moisture) by the composition, which may lead to an increased shelf-life. For example, incorporation of silicon dioxide (e.g., SIPERNAT® 50 S) may prevent premature absorption.

In some embodiments, each high-shear mixer 24 can run a first mix cycle. High-shear mixer 24 may run the first mix with a rotor speed and/or a rotating pan speed. In some embodiments, the first mix rotor speed may range from about 20 rpm to about 100 rpm. In some embodiments, the first mix rotating pan speed may range from about 20 rpm to about 100 rpm. The high-shear mixer can run the first mix for a mix cycle time. In some embodiments, the first mix cycle time may range from about 1 min. to about 10 min. The mix cycle time, rotor speed, and rotating pan speed can be preset, or can be calculated by control system 50 based on characteristics of the ingredients. The mix cycle time may be chosen to ensure that the ingredients in the first mix are thoroughly and homogenously combined. Oversized granules (i.e., “overs”) generated during manufacturing of previous batches of the end-product can be added to the first mix according to a ratio calculated by control system 50. These overs may be added to the first mix at a preset time during the mix cycle time. In some embodiments, the overs may be added closer to the end of the mix cycle time than to the beginning of the mix cycle time. As would be appreciated by one of skill in the art, adding the overs closer to the end of the mix cycle may be possible because the overs may already contain the appropriate and homogenized amounts of binders.

In some embodiments, each high-shear mixer 24 can run a second mix cycle after completion of the first mix cycle. Such a determination may be made by control system 50. In some embodiments, the second mix rotor speed may range from about 20 rpm to about 100 rpm. In some embodiments, the second mix rotating pan speed may range from about 20 rpm to about 100 rpm. In some embodiments, the second mix cycle time may range from about 1 min. to about 10 min. The second mix cycle time, rotor speed, and rotating pan speed can be preset, or may be calculated by control system 50 based on characteristics of the ingredients. Water may be added prior to and/or during the second mix cycle. Control system 50 may be configured to determine the amount of water added and the time course of this addition. At least one of the rotor speed and rotating pan speed of the high-shear mixer can differ between the first mix cycle and the second mix cycle. The addition of water and the adjustment to the rotor and rotating pan speed can activate the formation of granules in the high-shear mixer. Fines generated during manufacturing of previous batches of the end-product may be added during the second mix cycle. Control system 50 may be configured to determine the amount of fines added and the time course of this addition to stabilize the individualization of the granules, prevent the formation of agglomerations, make the granules flowable, stop the growth process of the granules, and/or prevent buildup on the primary classifier. In some embodiments, each high-shear mixer 24 may run additional mix cycles, for example, a third, a fourth, and/or a fifth mix cycle.

After completion of the last mix cycle, the granules may be discharged from high-shear mixer 24 to table feeder 26 (e.g., a Lancaster Products © table feeder). At this point, as would be appreciated by one of skill in the art, the fines added during the second mix cycle may be disbursed and coated on the granules. Table feeder 26 may be configured to feed primary classifier 28 (e.g., a Kason © classifier). Dust collected from the table feeder may be recycled for re-introduction into the high-shear mixer 24 as input material propelled by a blower 36. Primary classifier 28 can be configured to segregate granules by size, according to methods known to one of skill in the art. For example, primary classifier 28 may be configured to segregate granules exceeding a +6 mesh size. In some embodiments, primary classifier 28 may be configured to segregate granules exceeding a +5 mesh size or a +4 mesh size. These oversized granules may be collected (e.g., from the edge of a mesh screen of the primary classifier) and discharged to a receiving hopper 38. In some embodiments, a bucket elevator (not shown) may convey the oversized granules back above high-shear mixers 24. The oversized granules may be discharged into one or more second receiving weigh hoppers (not shown). In some embodiments, the one or more weigh hoppers may be used exclusively for overs. In some embodiments, the one or more weigh hoppers feed one or more weigh bins, and the weigh bins may be configured to add the overs to high-shear mixers 24 according to a ratio and time specified by the control system 50, as described above. In some embodiments, primary classifier 28 is not employed. In embodiments where a primary classifier is not employed, overs will be dried and separated in a secondary classification system and returned to the recycle bin or hopper, for example, via a recycle return 52 as shown in FIG. 7.

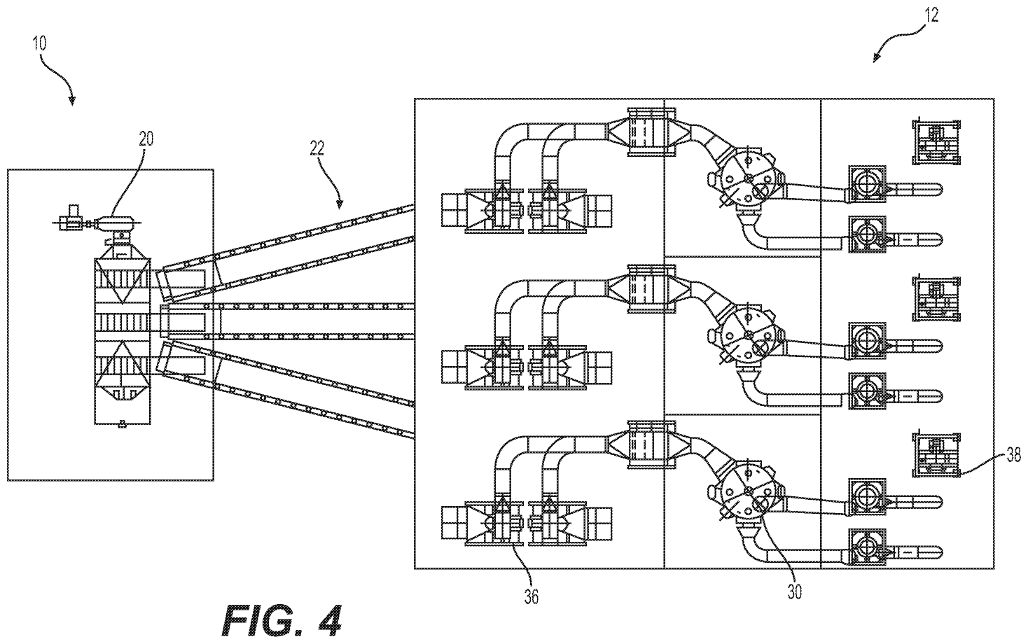

FIG. 4 is a top view of the processing system of FIGS. 1-3, at the elevation of fluidized bed dryers 30. As shown in FIG. 4, processing station 12 may be configured to dry the granules using fluidized bed dryer 30, consistent with disclosed embodiments. In some embodiments, granules meeting the specification of the primary classifier may enter fluidized bed dryer 30. For example, these granules may drop through primary classifier 28 and into fluidized bed dryer 30. Fluidized bed dryer 30 may be configured to dry the granules to a predetermined moisture content. As a non-limiting example, fluidized bed dryer 30 may be configured to dry the granules to approximately less than about 25% moisture content or less than about 10% moisture content. The temperature and duration of the drying may be determined by control system 50. Dust collected from fluidized bed dryer 30 may be recycled for re-introduction into high-shear mixer 24 as an input material, for example, via recycle return 52 as shown in FIG. 7.

In some embodiments, a rotary kiln may be used in lieu of a fluidized bed dryer. As will be appreciated by a person of ordinary skill in the art, the decision to use a fluidized bed dryer or a rotary kiln may be influenced by, e.g., the desired moisture content of the product.

As show in FIGS. 1 and 2, fluidized bed dryer 30 may be configured to discharge the dried granules into fluidized bed cooler 32. Fluidized bed cooler 32 may be configured to dry the granules to a predetermined temperature, e.g., a temperature ranging from about 350° F. to about 475° F. As a non-limiting example, fluidized bed cooler 32 may be configured to cool the granules to a storage temperature. The duration of the cooling may be determined by control system 50. For example, in some embodiments, the granules may be cooled over a period of about 10 seconds to about 60 seconds, to a temperature of about 90° F. to about 120° F. Dust collected from fluidized bed cooler 32 may be recycled for re-introduction into high-shear mixer 24 as an input material.

As shown in FIGS. 1 and 2, the dried, cooled granules then may be discharged onto secondary classifier 34 (e.g., a Kason © classifier). Secondary classifier 34 may be configured to segregate granules by size into granules falling within a specified size distribution for a product (e.g., −10 mesh to +60 mesh, or 2.0-250 μm, or −8 mesh +60 mesh, or 2.36-250 μm, for absorbent cat litter), according to methods known to one of skill in the art. In some embodiments, granules with a size distribution of −3½ to +8 mesh, or 5.6 mm to 2.36 mm, may be suitable for use as a fertilizer. In some embodiments, granules with a size distribution of +¼ to +6 mesh, or 6.3 mm to 3.35 mm, may be suitable for use as a recovered sorbent. For example, secondary classifier 34 may be configured to segregate granules exceeding approximately a 10 mesh size (2.0 mm) or an 8 mesh size (2.36 mm). These oversized granules may be collected (e.g., from the edge of a mesh screen of the secondary classifier) and discharged to a receiving hopper (not shown). As an additional example, secondary classifier 34 may be configured to segregate granules less than approximately a 60 mesh size (250 μm). These undersized granules may be collected (e.g., by a collector positioned below the secondary classifier) and discharged into a receiving hopper (not shown). In some embodiments, a bucket elevator or rotary airlock can convey the oversized granules and the undersized granules to a mill where they are milled into fines. For example, the oversized granules and the undersized granules may be milled to a size below approximately a 100 mesh (0.149 mm). As described above, these fines may be conveyed (e.g., by a bucket elevator pneumatic conveying piping) to a storage system (e.g., one or more silos) configured to discharge them into the high-shear mixers 24. In some embodiments, the oversized particles may be directly introduced into the next batch and get reduced in size by the higher-shear mixer's 24 normal operation. As described above, these fines may be reentered into a future batch. Granules that fall within the specified particle size distribution for a given end product may be pneumatically conveyed to final product storage bins (not shown).

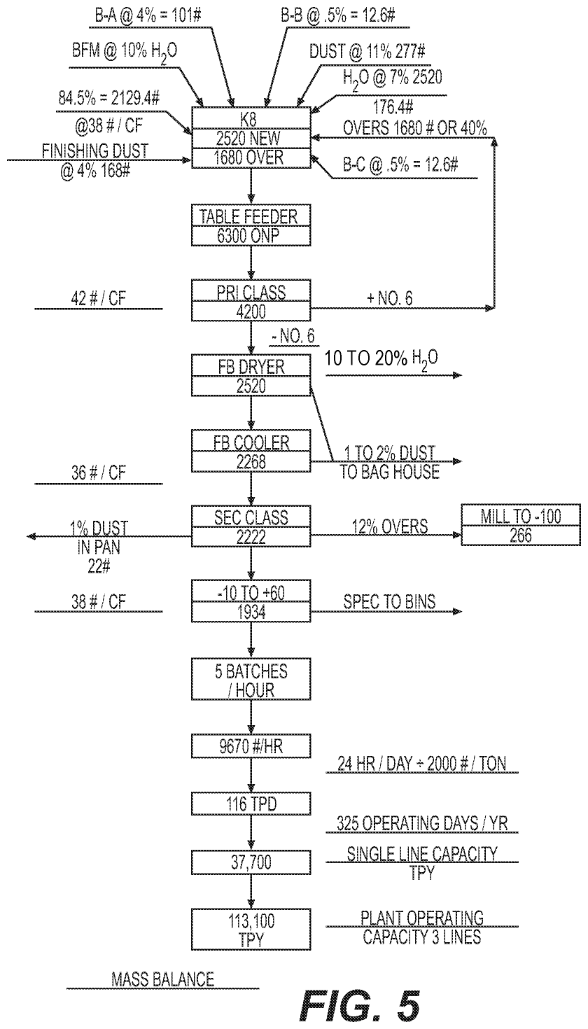

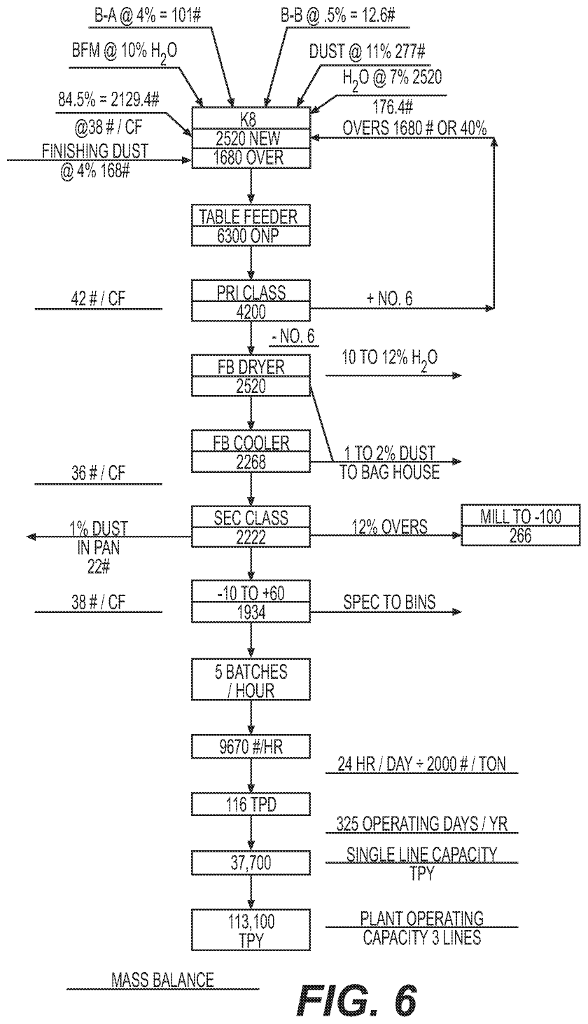

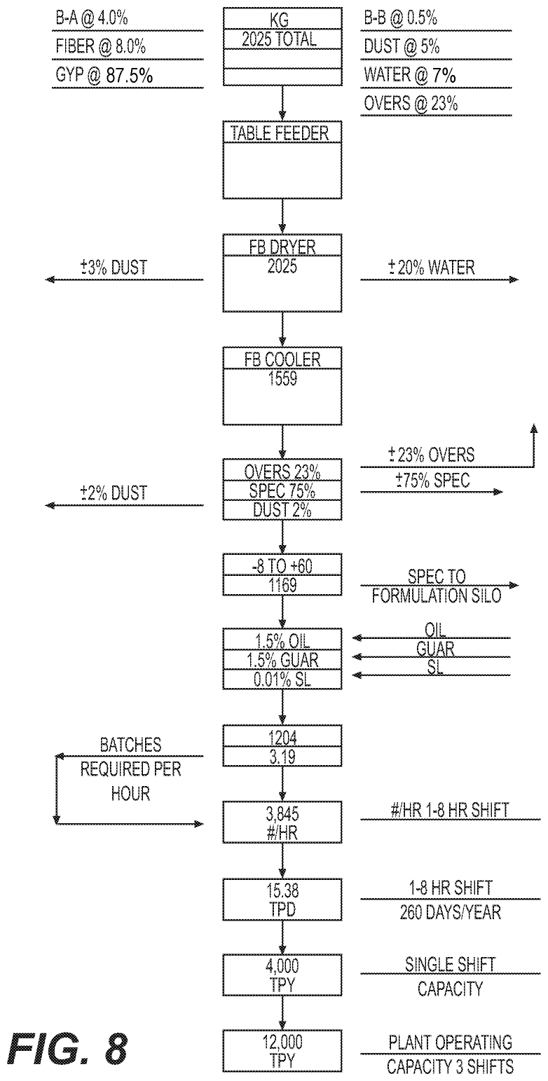

FIG. 5, FIG. 6, and FIG. 8 show exemplary processes for producing product, each of which is consistent with embodiments disclosed herein. Each of these exemplary processes may vary according to the ingredients, ratio of components, time for mixing, drying, classifying, etc., and they vary based on their output (properties, amount, etc.). Furthermore, each of these exemplary processes may vary based on parameters measured (e.g., ingredient properties) by control system 50.

As shown in FIG. 7, a primary classifier may not be required to effect a process in accordance with the embodiments disclosed herein. Here, in such an arrangement, material from a surge bin 40, recycle hopper 42, and/or dispensing unit(s) 44, after being mixed in high-shear mixer 24 and conveyed onto table feeder 26, may directly enter into fluidized bed dryer 30, without any primary classification. Classification, via secondary classifier 34, may occur after drying in fluidized bed dryer 30. Here, during the classification process, any dust, overs, and/or fines may be reintroduced via recycle hopper 42. Any collected dust, overs, and/or fines may be returned to the start of the process via recycle return 52. Additionally, product may be collected in product receptacle 46 after being cooled in fluidized bed cooler 32. From here, product may be further processed, e.g., an additive such as a fragrance agent and/or a coloring agent may be added, and/or the product may be discharged at discharge point 48. At discharge point 48, product may be loaded into a container (e.g., for retail sale or for resale) or it may be further processed.

Product Compositions

In some embodiments, disclosed herein is a product. In some embodiments, the product may comprise an input material. In some embodiments, the product may further comprise fibers. In some embodiments, the product may further comprise a binder. In some embodiments, the product may further comprise moisture. In some embodiments, the product may further comprise at least one additive. In some embodiments, the product may comprise an input material, fibers, a binder, and moisture. In some embodiments, the product may comprise an input material, fibers, a binder, moisture, and at least one additive.

In some embodiments, the input material may be chosen from gypsum, artificial pozzolans, natural pozzolans, chicken litter, wood ash, lime (e.g., hydrated lime), wastewater sludge, fly ash, periclase, quartz, and a mixture thereof. In some embodiments, the input material may be gypsum. In some embodiments, the input material may be artificial pozzolans. in some embodiments, the input material may be natural pozzolans. In some embodiments, the input material may be chicken litter. In some embodiments, the input material may be wood ash. In some embodiments, the input material may be lime. In some embodiments, the input material may be wastewater sludge. In some embodiments, the input material may be fly ash. In some embodiments, the input material may be periclase. In some embodiments, the input material may be quartz.

In some embodiments, the gypsum may be chosen from natural gypsum and synthetic gypsum (e.g., FGD gypsum). In some embodiments, the artificial pozzolans may be chosen from metakaolin, fly ash, silica fume, and burned organic matter (e.g., rice husk ash). In some embodiments, natural pozzolans may be chosen from volcanic ashes, pumices, volcanic glass, zeolites, and diatomaceous earth. In some embodiments, the input material may contain moisture. In some embodiments, the input material may be anhydrous. In some embodiments, the input material may be present in an amount ranging from about 0% to about 99% by weight, about 10% to about 75% by weight, about 0% to about 50% by weight, or about 0% to about 1% by weight.

In some embodiments, the fibers may be chosen from milled construction paper cuttings, paper mill sludge, diaper fluff, post-consumer recycled fiber, textile fibers, and a mixture thereof. In some embodiments, the fibers may contain moisture. In some embodiments, the fibers may be anhydrous. In some embodiments, the fibers may be present in an amount ranging from about 0% to about 40% by weight, about 10% to about 35% by weight, about 5% to about 30% by weight, about 0% to about 15% by weight, or about 0% to about 1% by weight.

In some embodiments, the binder may be chosen from cellulose ethers, silicon dioxide, starch, lime-based ash byproduct, and a mixture thereof In some embodiments, the cellulose ether may comprise sodium carboxymethylcellulose. In some embodiments, the starch may be chosen from off-specification corn starch powder and nonrecycled corn starch powder. In some embodiments, the binder may contain moisture. In some embodiments, the binder may be anhydrous. In some embodiments, the binder may be present in an amount ranging from about 0% to about 30% by weight, about 5% to about 25% by weight, about 0% to about 15% by weight, or about 0% to about 1% by weight.

In some embodiments, the additive may be chosen from a fragrance agent, a coloring agent, a surfactant, and an odor control agent. In some embodiments, the additive may be a fragrance agent. In some embodiments, the additive may be a coloring agent. In some embodiments, the additive may be a surfactant. In some embodiments, the additive may be an odor control agent.

In some embodiments, the fragrance agent may confer a pleasant smell (e.g., flowers, fresh-cut grass, fruit, etc.). In some embodiments, the fragrance agent may be present in an amount ranging from about 0% to about 7% by weight, about 0% to about 3% by weight, or about 0% to about 1% by weight.

In some embodiments, the coloring agent may change the natural color of the product. In some embodiments, the coloring agent may confer a color change to the product when a liquid is absorbed. In some embodiments, the coloring agent may be present in an amount ranging from about 0% to about 5% by weight, about 0% to about 2% by weight, or about 0% to about 0.5% by weight.

In some embodiments, the surfactant may improve clumping of the product. In some embodiments, the surfactant may be present in an amount ranging from about 0% to about 2% by weight, about 0% to about 0.1% by weight, or about 0% to about 0.001% by weight.

In some embodiments, the odor control agent may neutralize or trap one or more odors. In some embodiments, the odor control agent may be chosen from coconut and bituminous coal-based granular activated carbon. In some embodiments, the odor control agent may be about 12×30 mesh size. In some embodiments, the odor control agent may be present in an amount ranging from about 0% to about 7% by weight, about 0% to about 3.5% by weight, or about 0% to about 1% by weight.

In some embodiments, the product may contain moisture. In some embodiments, the amount of moisture may range from about 0% to about 50% by weight. In some embodiments, the amount of moisture may be less than about 50%, about 45%, about 40%, about 35%, about 30%, about 25%, about 20%, about 15%, about 10%, about 5%, about 4%, about 3%, about 2%, or about 1% by weight. In some embodiments, the amount of moisture may range from about 40% to about 50% by weight, about 30% to about 40% by weight, about 20% to about 30% by weight, about 10% to about 20% by weight, or about 0% to about 10% by weight.

Product Form & Properties

The product of the processes disclosed herein may be in the form of granules, pellets, beads, powder, particles, and the like. As will be appreciated by the skilled artisan, some forms may be more amenable to a particular application than others. For example, granules may be suitable as a cat litter, whereas a finer powder-like form may be more suitable to soak up liquid in a spill. Certain terms may be used interchangeably, for example, “granules” and “pellets;” the use of one term is not meant to be exclusive of the other unless the context suggests otherwise.

In some embodiments, the product may range in size from about 3.35 mm to about 250 μm, about 2.80 mm to about 250 μm, or about 2.36 mm to about 250 μm. In some embodiments, the product may be about 2.36 mm to 250 μm in diameter.

In some embodiments, the product may be uniformly round and smooth. In some embodiments, the roundness of the product may be random. Similarly, in some embodiments, the product may have varying degrees of jaggedness across its surface.

In some embodiments, the product will be hydrophilic. In some embodiments, the product may absorb water and become fully saturated in less than about 10 seconds, less than about 5 seconds, less than about 4 seconds, less than about 3.5 seconds, less than 3 seconds, less than about 2.5 seconds, less than about 2 seconds, less than about 1.5 seconds, less than about 1 second, or less than about 0.5 seconds.

In some embodiments, the product may not aggregate after wetting (i.e., the product granules, pellets, etc. remain individualized). In some embodiments, the product may aggregate (i.e., it clumps) during or after wetting.

In some embodiments, the pH of the product may range from about pH 5 to about pH 12. In some embodiments, the pH of the product may range from about pH 6 to about pH 11. In some embodiments, the pH of the product may range from about pH 7 to about pH 10. In some embodiments, the pH of the product may range from about pH 7.5 to about pH 9.5.

In some embodiments, the product may be odor-free. In some embodiments, the product may be odorous.

Exemplary Uses

The products and processes disclosed herein are not intended to be limited to a particular application. Reference to a particular application, for example, cat litter (or animal litter generally), absorbent material in a spill response kit, desiccant, oil absorbents, soil amendments, erosion control materials, fertilizers, and the like, is exemplary and not intended to be limiting.

### EXAMPLE 1

### Sorbent Granules

FIG. 5 shows an exemplary mass balance flow chart for producing a product according to the present disclosure. As shown in FIG. 5, sorbent granules may be created according to the following process steps, consistent with disclosed embodiments. A first mixer (e.g., paddle mixer 20) may mix gypsum and cellulose fibers to produce a first combination. A second, high-shear mixer (e.g., high-shear mixer 24) may then mix the first combination with dust, water, and optionally at least one of wet overs, starch, silicon dioxide, and sodium carboxymethylcellulose to produce granules. The relative proportions of these ingredients may be determined by a programmable logic controller (e.g., control system 50) based on ingredient variability. Similarly, ratios of input materials may be determined based on, e.g., desired final product requirements such as absorption, clumping, granule hardness, granule density, dusting, odor control, particle flowability, and the like. In a homogenization stage, the first combination may be mixed with dust and optionally with at least one of starch, silicon dioxide, and sodium carboxymethylcellulose to produce a second combination. The dust may act as seed particles, aiding granulation. In a granulation stage, water may be added to the second combination to form granules. Overs, wet or dry, may be added during or before the granulation stage. In a dusting stage, additional dust may be added to coat the granules, inhibiting agglomeration and the further growth of the granules, making the granules flowable, and preventing buildup on the primary classifier.

In some embodiments, the second combination may comprise, by weight: about 60% to about 95% gypsum; about 1% to about 10% cellulose fibers; about 1% to about 8% corn starch powder; about 0% to about 2% silicon dioxide; about 0% to about 4% high purity sodium carboxymethylcellulose; about 2% to about 20% dust for assisting granulation (e.g., fines generated by milling dried granules); about 1% to about 4% dust for coating the granules (e.g., fines generated by milling dried granules); about 2% to about 35% water additional water added to the second combination; and about 10% to about 50% undried or dried oversized material from prior mixes.

A primary classifier (e.g., primary classifier 28) may separate wet overs exceeding a first size from the granules. A fluidized bed dryer (e.g., fluidized bed dryer 30) may dry the granules and a fluidized bed cooler (e.g., fluidized bed cooler 32) may cool the dried granules. A secondary classifier (e.g., secondary classifier 34) may separate the dry overs and dry fines outside a size range from the dried, cooled granules. The dry overs and dry fines outside the size range may be milled to produce dust that can be re-introduced into the high-shear mixer (e.g., high-shear mixer 24), or directly re-introduced into the mixer (e.g., paddle mixer 20).

The resulting sorbent granules may comprise, by weight: gypsum, about 60 to about 95%; cellulose fibers, about 1 to about 10%; starch about 1 to about 8%; silicon dioxide, about 0 to about 2%; carboxymethylcellulose, about 0% to about 4%; and moisture, about 0% to about 25%. The sorbent granules may have at least some of the following characteristics: about 95 to about 100% of granules can fall within about 2.00 mm to 250 μm, or about 2.36 mm to 250 μm; granules may be highly hydrophilic, with wetting and absorption occurring in less than 3 seconds; granules may remain individualized after wetting, for example they may not meld upon wetting; granules may have pH between 7.5 and 9.5; granules may be odor free; and granule color can be approximately khaki in HTML/CSS.

FIG. 6 shows an exemplary mass balance flow chart for a similar process, which results in the production of about 113,000 tons of granules per year, according to an exemplary embodiment. The process is the same as that shown and described herein with respect to FIG. 5, except the process shown in FIG. 6 does not utilize silicon dioxide. Similarly, FIG. 8 shows a mass balance flow chart for another similar process, which results in the production of about 12,000 tons of granules per year.

In some embodiments of the process and product disclosed herein, an ash byproduct may be the sole binder. The percent of ash byproduct utilized may be varied to produce the desired product (e.g., sorbent granules) with the desired characteristics. Per federal and state clean air regulations, companies in the utility and industrial sectors are controlling their SO₂ emissions using lime-based spray dryer absorbers (SDA), dry flue-gas desulfurization scrubbers (DFGD), fluidized bed combustion (FBC), and Dry Sorbent Injection (DSI). Each of these emission control technologies produce a lime-based ash byproduct. This lime-based ash byproduct may be processed to separate a portion or the majority of normal fly ash produced by the boiler, thereby producing a more concentrated lime based ash byproduct. This concentrated lime-based ash byproduct may be used to reduce or replace the other binder(s) (e.g., powdered, liquid, and recycled corn starch) utilized in the disclosed process used to produce the disclosed product (e.g., absorbent granules).

The lime-based ash byproduct may also be used to reduce or replace other binders (powdered and liquid sodium lignosulfonate, powdered and liquid calcium lignosulfonate, etc.), which may be used in the disclosed process and product or in other pelletization, extrusion, and granulation processes. The primary material utilized in these processes for making pellets or granules may include, for example, synthetic gypsum, natural gypsum, chicken litter, wood ash, lime, wastewater sludge, fly ash, and the like.

By reducing or replacing the other, more costly binder(s) utilized in the processes and product disclosed herein with concentrated lime-based ash byproduct produced from SDA ash, DFGD ash, FBC ash, or DSI ash, the cost to produce the sorbent granules may be reduced. And while reducing the cost, the concentrated lime-based ash byproduct can still produce end-products (e.g., sorbent granules) having generally the same stability, hardness, and other characteristics. However, utilizing the concentrated lime-based ash byproduct may provide additional advantages, including, for example, increased product strength, increased product hardness, and increased quality and value. By varying the ratio of these lime-based ash byproducts, granules may be more absorbent, stronger, dense, allow for pH adjustment, exhibit enhanced clumping, reduced dust, and may eliminate odor. For example, when the sorbent granules are utilized in agricultural applications, the inclusion of sulfur and lime in the granules may enhance the quality and value.

In some embodiments, these ash byproducts may be granulated without the addition of other ingredients. This may be accomplished by combining water with these ash byproducts and granulating to produce a densified or agglomerated granular product for use as, e.g., a cement kiln feed or other industrial application, e.g., glass manufacturing, concrete applications, fertilizers, and block manufacturing.

1. A process for manufacturing granules comprising:
mixing and granulating gypsum, fibers, and water using a high-shear mixer to produce wet granules;
separating wet overs from the wet granules using a primary classifier; and
drying and cooling the wet granules.

2. The process of claim 1, wherein the mixing and granulating comprises a homogenization stage, a granulation stage, and a dusting stage.

3. The process of claim 1, wherein at least one of seed particles, wet overs, a binder, silicon dioxide, and sodium carboxymethylcellulose is added to the gypsum and the fibers during the homogenization stage.

4. The process of claim 2, wherein the water is added to the gypsum and the fibers during the granulation stage.

5. The process of claim 2, wherein dust is added to the gypsum and the fibers during the dusting stage.

6. The process of claim 1, wherein manufacturing granules further comprises:
separating at least one of dry overs and dry fines from the dried, cooled granules using a secondary classifier.

7. The process of claim 6, wherein manufacturing granules further comprises:
milling the dry overs and dry fines to produce a dust and adding the dust into the mixer.

8. The process of claim 6, wherein manufacturing granules further comprises:
adding the dry overs and dry fines into the mixer.

9. The process of claim 7, wherein mixing and granulating further comprises incorporating reclaimed wet overs and reclaimed dust into the wet granules.

10. The process of claim 3, wherein the binder comprises a starch.

11. The process of claim 3, wherein the binder comprises a lime based ash byproduct.

12. The process of claim 11, wherein the lime based ash byproduct is produced from at least one of spray dryer absorber ash, dry flue-gas desulfurization scrubber ash, fluidized bed combustion ash, and dry sorbent injection ash.

13. The process of claim 12, wherein the lime based ash byproduct is a concentrated lime based ash byproduct produced by separating out a portion of a normal fly ash.

14. The process of claim 3, wherein the binder comprises a combination of starch and lime based ash byproduct.

15. The process of claim 14, wherein a strength and a hardness of the granules increases as the concentration of lime base ash byproduct is increased versus the concentration of starch.

16. A process for manufacturing granules comprising:
mixing and granulating input material, fibers, a binder, and water using a mixer to produce wet granules;
drying and cooling the wet granules; and
separating at least one of dry overs and dry fines from the dried, cooled granules using a classifier.

17. The process of claim 16, wherein manufacturing granules further comprises:
milling the dry overs and dry fines to produce a dust and adding the dust into the mixer.

18. The process of claim 16 or 17, wherein manufacturing granules further comprises:
adding the dry overs and dry fines into the mixer.

19. A product comprising a granulated mixture of an input material, fibers, a binder, and moisture.

20. The product of claim 19, wherein the input material comprises synthetic gypsum.

21. The product of claim 19, wherein the fibers comprise cellulose fibers.

22. The product of claim 19, wherein the binder comprises starch.

23. The product of claim 19, wherein the granulated mixture further comprises an additive.

24. The product of claim 19, wherein the binder is carboxymethylcellulose.

25. The product of claim 19, wherein the binder is silicon dioxide.

26. The product of claim 19, wherein the binder is a combination of carboxylmethylcellulose and silicon dioxide.

27. The product of claim 19, wherein the granulated mixture comprises at least 50% by weight granules between 2.36 mm and 250 11 mm in diameter.

28. The product of any one of claims 19 to 26 claim 19, wherein the granulated mixture comprises at least 95% by weight granules between 2.36 mm and 250 11 mm in diameter.

29. The product of claim 19, wherein the binder is a lime based ash byproduct.

30. The product of claim 29, wherein the lime based ash byproduct is produced from at least one of spray dryer absorber ash, dry flue-gas desulfurization scrubber ash, fluidized bed combustion ash, and dry sorbent injection ash.

31. The product of claim 30, wherein the lime based ash byproduct is a concentrated lime based ash byproduct produced by separating out a portion of a normal fly ash.

32. The product of claim 19, wherein the binder includes a combination of starch and lime based ash byproduct.

33. The product of claim 32, wherein a product strength and a product hardness increase as the concentration of lime base ash byproduct is increased versus the concentration of starch.

34. The product of claim 19, wherein an amount of the input material in the granulated mixture ranges from about 0% to about 99% by weight, about 10% to about 75%) by weight, about 0% to about 50% by weight, or about 0% to about 1% by weight.

35. The product of claim 19, wherein an amount of the fibers in the granulated mixture ranges from about 0% to about 40% by weight, about 10% to about 35% by weight, about 5% to about 30% by weight, about 0% to about 15% by weight, or about 0% to about 1% by weight.

36. The product of claim 19, wherein an amount of the binder in the granulated mixture ranges from about 0% to about 30% by weight, about 5% to about 25% by weight, about 0% to about 15% by weight, or about 0% to about 1% by weight.

37. The product of claim 19, wherein an amount of the moisture in the granulated mixture ranges from about 40% to about 50% by weight, about 30% to about 40% by weight, about 20% to about 30% by weight, about 10% to about 20% by weight, or about 0% to about 10% by weight.

38. The product of claim 19, wherein the product is cat litter.

39-41. (canceled)
